(19) United States
(12) Patent Application Publication
(10) Pub. No.: US 2006/0013318 A1
(43) Pub. Date: Jan. 19, 2006

(54) Video error detection, recovery, and concealment

(76) Inventors: Jennifer Webb, Dallas, TX (US); Felix C.A. Fernandes, Plano, TX (US)

Correspondence Address: TEXAS INSTRUMENTS INCORPORATED, P O BOX 655474, M/S 3999, DALLAS, TX, 75265, US

(21) Appl. No.: 11/158,974

(22) Filed: Jun. 22, 2005

Related U.S. Application Data
(60) Provisional application No. 60/582,354, filed on Jun. 22, 2004.

(51) Int. Cl. H04N 11/02; H04N 7/12; H04N 11/04; H04B 1/66

(52) U.S. Cl. 375/240.25

(57) ABSTRACT

Decoding for H.264 with error detection, recovery, and concealment including two parsing functions for efficient detection of errors in exp-Golomb codewords, recovery for error in the number of reference frames, skipping to an uncorrupted SPS/PPS NAL unit, and concealment of invalid gaps in frame number by separate gap size 2 and greater than size 2 analysis.

### CROSS-REFERENCE TO RELATED APPLICATIONS

This application claims priority from provisional application No. 60/582,354, filed Jun. 22, 2004. The following coassigned pending patent applications disclose related subject matter: 10/888,702, filed Jul. 9, 2004.

### BACKGROUND

The present invention relates to digital video signal processing, and more particularly to devices and methods for error handling in video decoding.

There are multiple applications for digital video communication and storage, and multiple international standards have been and are continuing to be developed. Low bit rate communications, such as, video telephony and conferencing, led to the H.261 standard with bit rates as multiples of 64 kbps, and the MPEG-1 standard provides picture quality comparable to that of VHS videotape.

H.264 is a recent video coding standard that makes use of several advanced video coding tools to provide better compression performance than existing video coding standards such as MPEG-2, MPEG-4, and H.263. At the core of all of these standards is the hybrid video coding technique of block motion compensation and transform coding. Block motion compensation is used to remove temporal redundancy between successive images (frames), whereas transform coding is used to remove spatial redundancy within each frame. Traditional block motion compensation schemes basically assume that objects in a scene undergo a displacement in the x- and y-directions; thus each block of a frame can be predicted from a prior frame by estimating the displacement (motion estimation) from the corresponding block in the prior frame. This simple assumption works out in a satisfactory fashion in most cases in practice, and thus block motion compensation has become the most widely used technique for temporal redundancy removal in video coding standards. FIGS. 2a-2b illustrate H.264 functions which include a deblocking filter within the motion compensation loop.

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264. The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264 uses an integer approximation to a 4×4 DCT.

The rate-control unit in FIG. 2a is responsible for generating the quantization step (qp) by adapting to a target transmission bit-rate and the output buffer-fullness; a larger quantization step implies more vanishing and/or smaller quantized transform coefficients which means fewer and/or shorter codewords and consequent smaller bit rates and files.

As more features are added to wireless devices, the demand for error robustness in multimedia codecs increases. At the very least, a decoder should not crash or hang, when processing corrupted data arising from bit-errors, burst-errors, or packet-loss errors that frequently occur in various operating environments. There may be a signaling mechanism (e.g., H.245) for the decoder to signal to the encoder that it needs a fresh start. However, this may result in the encoder continually restarting and is therefore unacceptable. Furthermore, in some scenarios, such as mobile TV, this type of signaling is unavailable.

Stockhammer et al., H.264/AVC in Wireless Environments, 13 IEEE Trans. Cir. Syst. Video Tech. 657 (2003) and Wenger, Common Conditions for Wire-Line Low Delay IP/UDP/RTP Packet Loss Resilient Testing, VCEG-N79, September 2001, describe H.264 error-resilience in a packet-loss environment, but they do not handle bit errors or burst errors. Varsa et al., Non-Normative Error Concealment Algorithms, VCEG-N79, September 2001, provide error-concealment techniques but they do not detect errors. Their method assumes that an external mechanism detects bitstream errors and notifies the decoder that a slice has not been decoded because it contains errors.

### SUMMARY OF THE INVENTION

The present invention provides video decoding methods with early error detection, error recovery, or error concealment for H.264 type bitstreams.

### BRIEF DESCRIPTION OF THE DRAWINGS

FIGS. 1a-1e are flow diagrams.

FIGS. 2a-2b show video coding functional blocks.

FIGS. 3a-3b illustrate applications.

### DESCRIPTION OF THE PREFERRED EMBODIMENTS

1. Overview

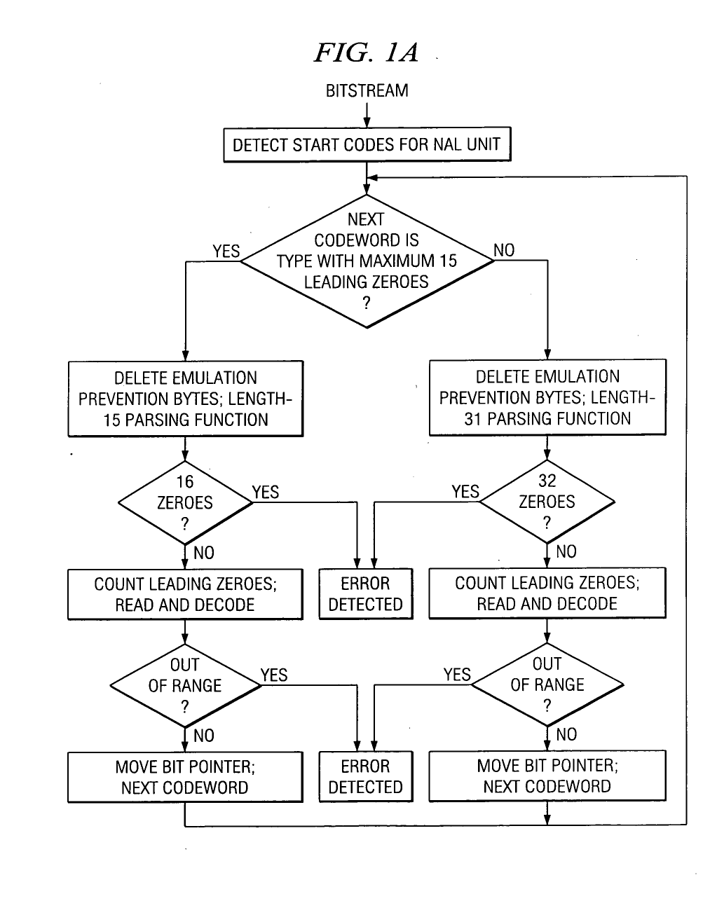

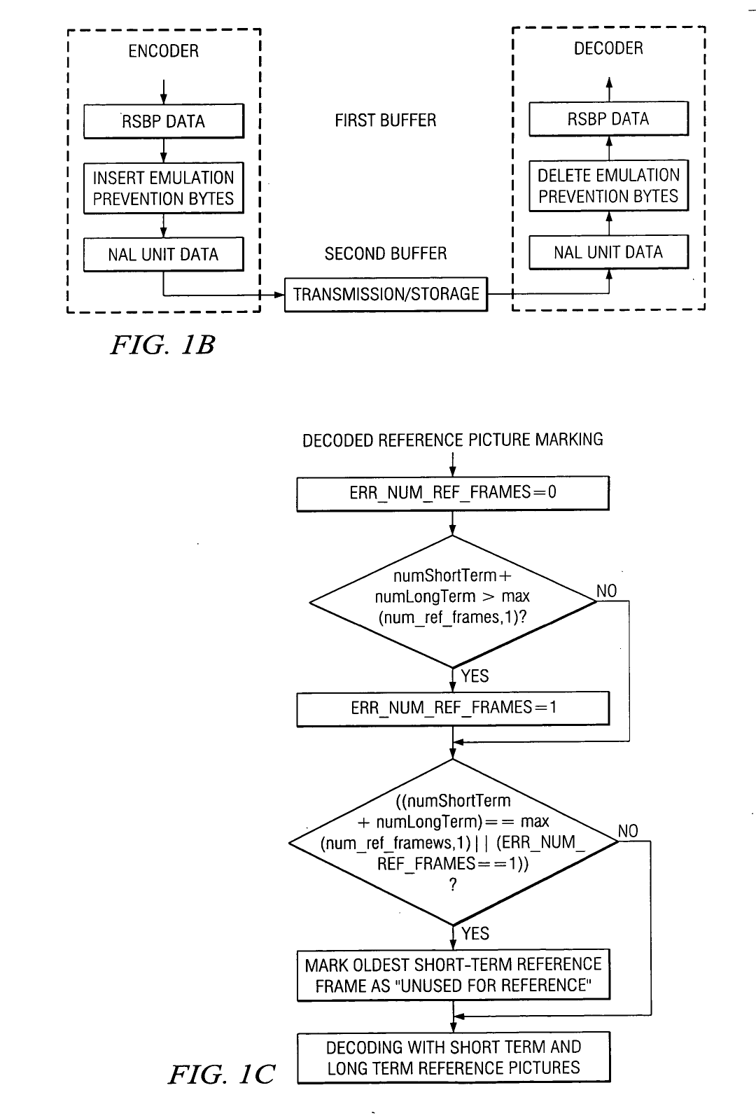

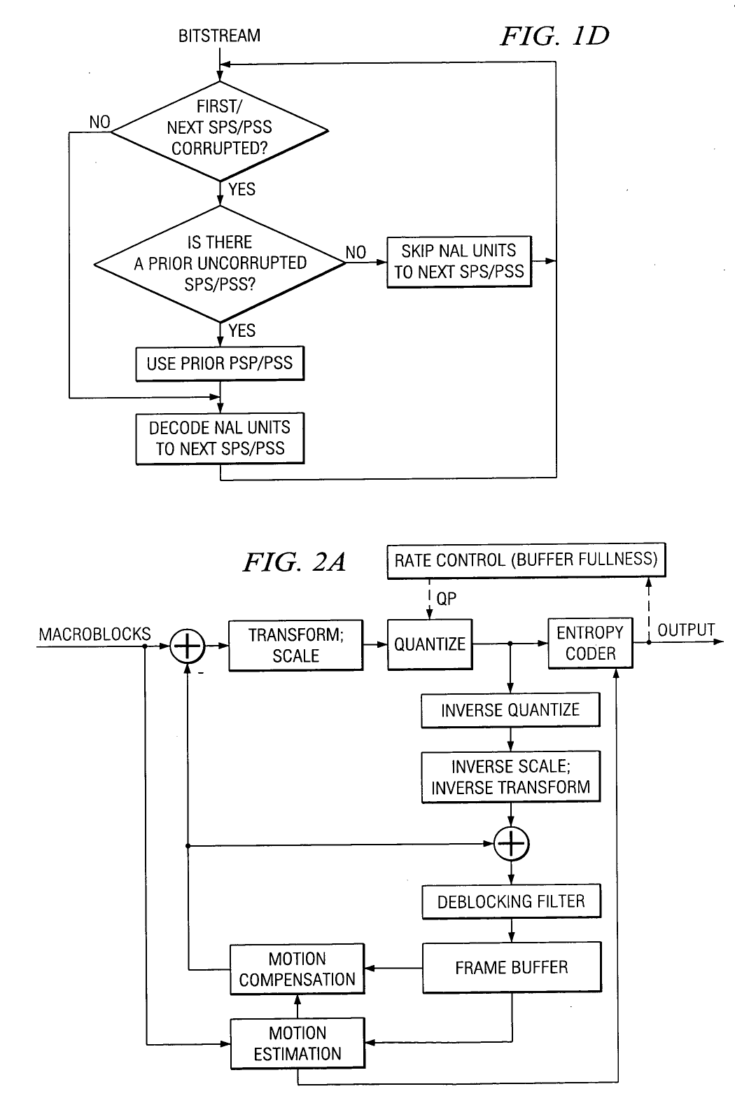

Preferred embodiment methods provide for an H.264 decoder to detect, recover from, and conceal bit-errors, burst-errors and packet-loss errors in a bitstream by using one or more of: two parsing functions (one for long exp-Golomb codes and one for short), num_ref frames error recovery by a test, skip to an uncorrupted SPS and/or PSS, and concealing invalid gaps of the frame_num by separately considering an increment of 2 from increments of more than 2. FIGS. 1a-1e are flow diagrams for these features.

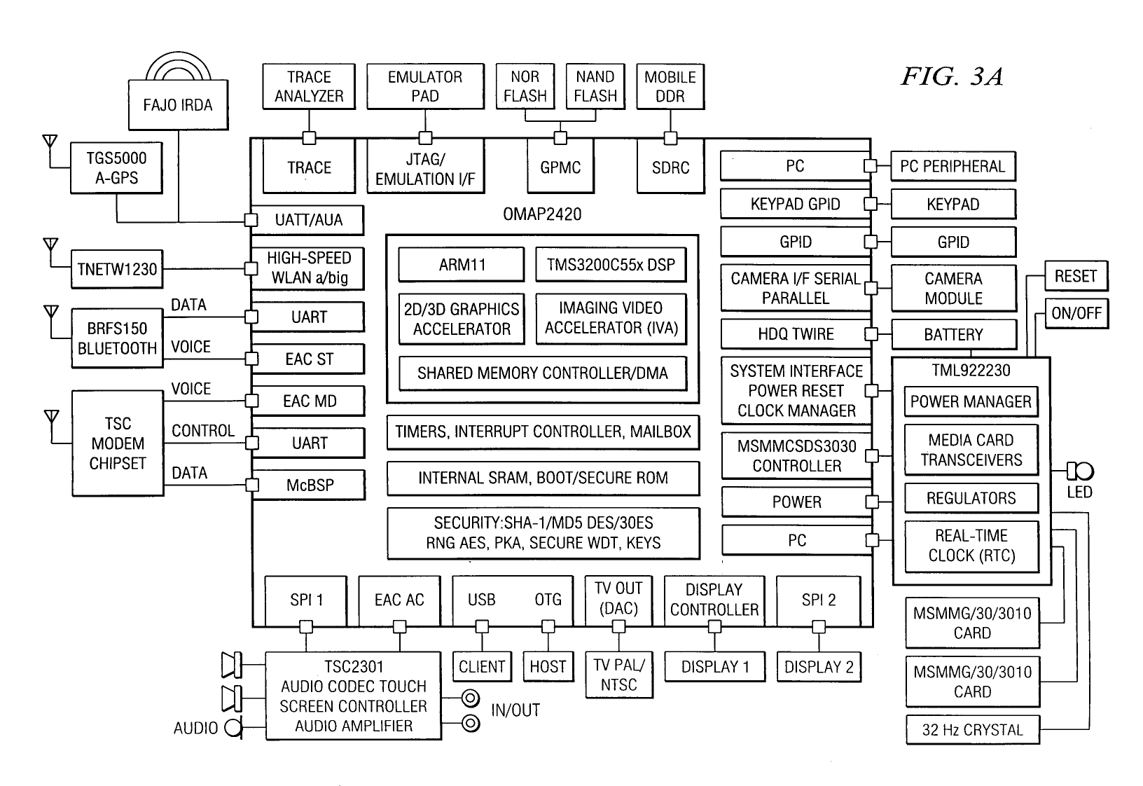

Preferred embodiment systems perform preferred embodiment methods with any of several types of hardware, such as cellphones, PDAs, notebook computers, etc. which may be based on digital signal processors (DSPs), general purpose programmable processors, application specific circuits, or systems on a chip (SoC) like multicore processor arrays or combinations of a DSP and a RISC processor together with various specialized programmable accelerators such as for image processing (e.g., FIG. 3a). A stored program in an onboard or external (flash EEP) ROM or FRAM could implement the signal processing methods. Analog-to-digital and digital-to-analog converters can provide coupling to the analog world; modulators and demodulators (plus antennas for air interfaces such as for video on cellphones) can provide coupling for transmission waveforms; and packetizers can provide formats for transmission over networks such as the Internet as illustrated in FIG. 3b.

Preferred embodiments include error detection methods, error recovery methods, and error concealment methods as described in the following sections.

2. Error detection

To describe preferred embodiment error detection methods, first review the H.264 bitstream format. The H.264 bitstream is composed of individually decodable NAL (network abstraction layer) units with a different RBSP (raw byte sequence payload) associated with different NAL unit types. NAL unit types include coded slices of pictures, with header information contained in separate NAL units, called a Sequence Parameter Set (SPS) and a Picture Parameter Set (PPS). An optional NAL unit type is Supplemental Enhancement Information (SEI), which, for example, may contain information useful for error detection, recovery, or concealment. Each bitstream must contain one or more SPSs and one or more PPSS. Coded slice data include a slice_header, which contains a pic parameter set_id, used to associate the slice with a particular PPS, and pic_order cnt fields, used to group slices into pictures. H.264 pictures and slices need not be transmitted in any particular order, but information about the ordering is contained in the RBSP, and is used to manage the Decoded Picture Buffer (DPB). H.264 supports multiple reference frames, to support content with periodic motion (short term reference frame) or that jumps between different scenes (long term reference frame). The SPS and PPS may be repeated frequently to allow random access, such as for mobile TV. Each NAL unit contains the nal unit type in the first byte, and is preceded by a start code of three bytes: 0x000001.

General Strategy For Detecting Invalid Decoded Syntax Elements

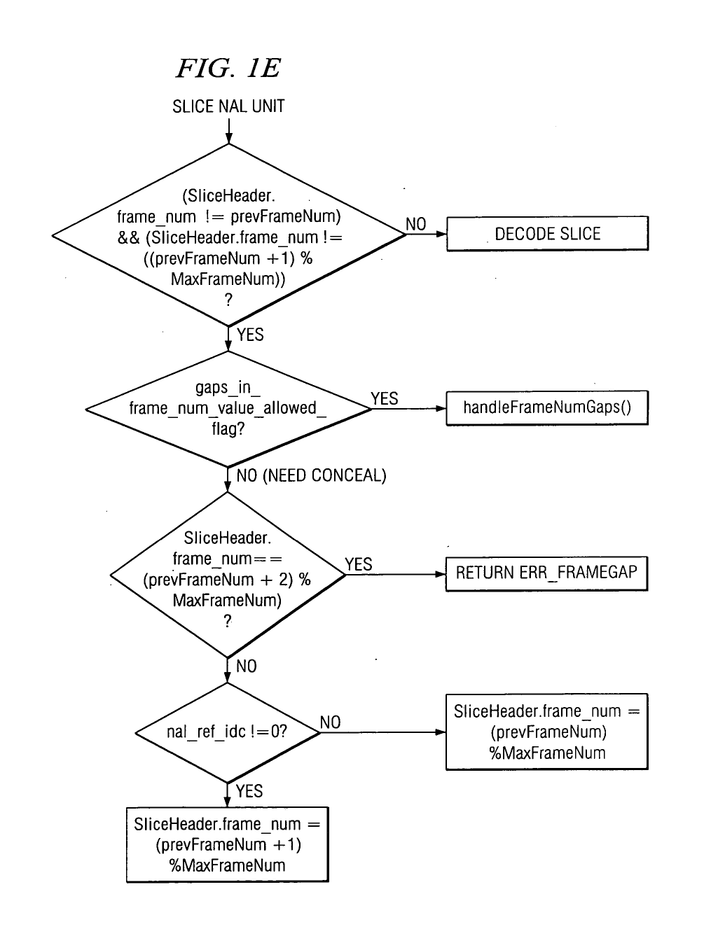

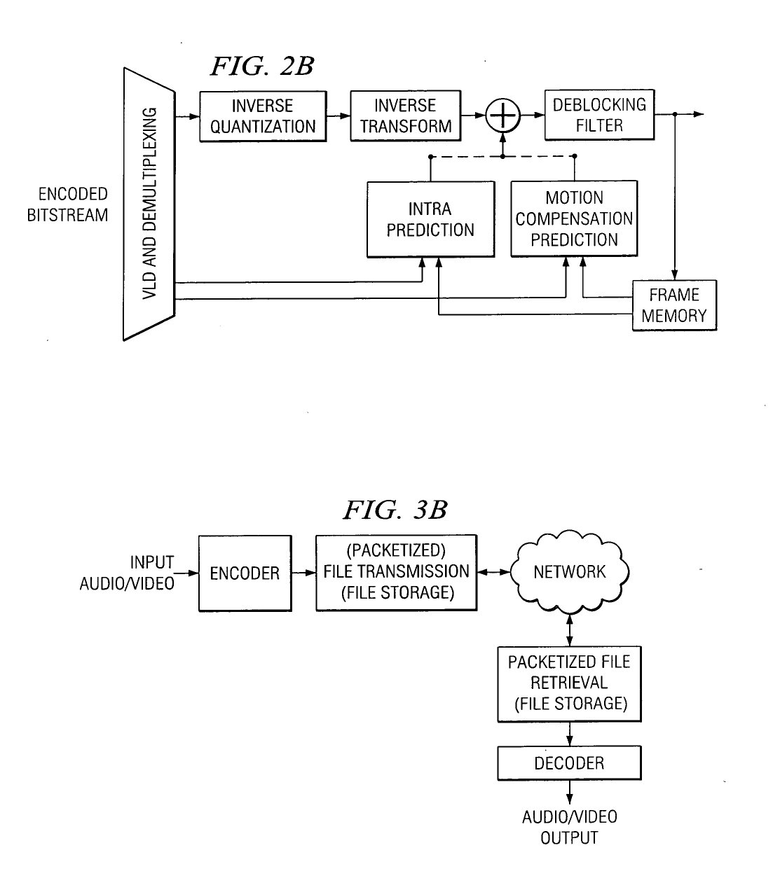

Errors are detected during decoding when a value lies outside the expected range. The valid range is generally specified as part of the H.264 standard, or can also be determined based on practical implementation, such as array sizes or known constraints from the encoding source. Some constraints from the encoding source may be known a priori, or may be transmitted as Supplemental Enhancement Information (SEI), such as Motion constrained slice group set. The tables in section 6 below give examples of error checking for H.264. Because the H.264 bitstream uses variable-length codewords (e.g., exponential-Golomb codes used by the entropy coder in FIG. 2a), it is difficult to avoid parsing errors which can result in consuming too much of the bitstream and reading past the next valid start code or resynchronization point. To detect parsing errors as early as possible, various preferred embodiments include the following method.

Early Detection Of Errors In Exp-Golomb Codes:

Exp-Golomb codes are structured with a variable number of leading zeroes, followed by a 1-bit, and then the same number of information bits as the number of leading zeroes; that is, a codeword has the form 00 . . . 01xₙxₙ₋₁ . . .x₀. H.264, subclause 9.1, parses Exp-Golomb codewords by counting the number of 0 bits until a 1 bit is reached (leadingZeroBits), and interprets leadingZeroBits bits after the 1 as the information bits, as described by the following pseudocode.

leadingZeroBits =-1;

for (b=0; !b; leadingZeroBits++)

b=read_bits(1);

codeNum=2ˆ(leadingZeroBits)−1+read_bits (leadingZeroBits)

With such methods, it is impossible to detect an error during parsing, because any number of leading zeroes, followed by a 1 plus the corresponding number of information bits, is interpreted as a codeword. However, due to range constraints, most codewords have a maximum of 15 leading zeroes, with the exceptions of the following syntax elements:

idr_pic_id,

delta_pic_order_cnt[0/1],

delta_pic_order_cnt_bottom,

offset_for top tobottom_field,

offset_for ref frame[i],

offset_for non_ref_pic,

bit rate_value_minus1,

cpb_size_value_minus1

Codewords for each of these may have up to 31 leading zeroes. Therefore, by creating two separate parsing functions to decipher length-15 and length-31 codenum values from Exp-Golomb codes, respectively, preferred embodiment methods can detect and report errors arising from excessive leading zeroes. This method allows for early error detection and prevents over-consumption of the bitstream which may result in a missed start code. By applying range-checking along with the specialized parsing of Exp-Golomb codes, a preferred embodiment H.264 decoder can detect bit-errors, burst-errors and packet-loss errors; see FIG. 1a.

In more detail (e.g., H.264 Annex B), begin decoding a NAL unit by finding start codes (0x0000001) which indicate the beginning and end of a byte stream NAL unit. This also determines NumBytesinNALunit. The extracted NAL unit's first byte indicates whether the NAL unit is a reference and identifies the NAL unit's type; e.g., an SPS, a PPS, a slice of a reference picture, a slice data partition of a reference picture, SEI, and so forth. Deletion of emulation prevention bytes (which prevent emulation of start codes) then yields the NAL unit's raw byte sequence payload (RBSP) for decoding.

For example, a NAL unit of the SPS type has the first byte in the RBSP as a profile indicator (profile idc), the second byte as including some flags, and the third byte as a level indicator (level idc). But after these three bytes, a sequence of Exp-Golomb codewords (with value ranges) appears:

seq_parameter_set_id, (0 to 31)
log2_max_frame_num_minus4, (0 to 12)
pic_order_cnt_type, (0 to 2)
if pic_order_cnt_type == 0, then

log2_max_pic_order_cnt_lsb_minus4, (0 to 12)

else if pic_order_cnt_type == 1, then

delta_pic_order_alwasy_zero_flag (1 bit)
offset_for_non_ref_pic, (−2³¹ to 2³¹ − 1)
offset_for_top_to_bottom_field, (−2³¹ to 2³¹ − 1)
num_ref_frames_in_pic_order_cnt_cycle, (0 to 255)
offset_for_ref_frame[i], (−2³¹ to 2³¹ − 1)

. . .

That is, the RBSP contains a mixture of length-15 and length-31 Exp-Golomb codewords appearing in different branches. Thus having a length-15 parsing function allows earlier detection of errors that result in 16 or more consecutive zeros. In addition, errors such as four leading 0s are detected when checking the range for log2_max pic_order cnt_lsb_minus4. Alternatively, a generalized routine can be implemented that accepts the maximum number of leading zeros as a parameter.

The following pseudocode implements a preferred embodiment parsing Exp-Golomb codewords with a maximum number of leading 0s as maxZeros:

temp = show_bits(maxZeros+1);
if (temp==0) { codeNum = ERR_DATA; return ;} // ERR_DETECT

bits = maxZeros;

for (N=1; ((temp>>bits)&0×1)!=1; N++, bits−−);
flush_bits(N); // read past leading 0s and following 1-bit
leadingZeroBits = N−1;
codeNum = 2\hat{ }(leadingZeroBits) − 1 + read_bits (leadingZeroBits)

The preferred embodiment methods may use double buffering as in FIG. 1b for deletion of emulation prevention bytes which may be combined with the decoder parsing as suggested in FIG. 1a.

3. Error Recovery

This section describes preferred embodiment error recovery methods, and this depends upon the H.264 bitstream format.

General Strategy For Error Recovery

In most cases, parsing stops as soon as an error is detected, and decoding resumes at the next start code. Each macroblock has a status that is initialized to a bad value. If no errors are detected at the end of the slice, each macroblock status for that slice is set to a good value. If an error is detected in the slice, the slice (or data partition) is not trusted, because other errors may not be detectable, and errors may often occur in bursts. When an error is detected, all macroblocks in the slice retain their initialized bad value, and errors can be concealed after all slices have been decoded for the picture (with a particular pic_order cnt). The preferred embodiment method does not try to recover data from a corrupted slice, because a missed error may degrade quality too severely. Encoding a picture with multiple slices greatly improves error recovery.

Often, when an invalid value is decoded, it must be set to some valid value to avoid unpredictable results, particularly for syntax elements in the sequence parameter set (SPS) and picture parameter set (PPS).

Occasionally, when an error is detected in a syntax element with a fixed-length code, it may be possible to assume a correct value and continue parsing. However, in harsh error conditions with burst errors, an error in a fixed-length code might be the only opportunity to detect and conceal errors. For this reason, the preferred embodiment method stops parsing even for errors occurring in a fixed-length code.

For efficient resynchronization, the preferred embodiment method uses the double-buffering scheme of FIG. 1b. With this scheme, the buffer always begins with a start code, and stuffing bytes that prevent start-code emulation are removed as the buffer is replenished. By performing some parsing while filling the buffer, error recovery is simplified.

Error Recovery When Specific Syntactic Constructs Are Corrupted

A) Recovering From An Error In The Num_Ref Frames Syntax Element:

The num_ref frames syntax element describes the maximum size of a window of reference frames within the Decoded Picture Buffer (DPB). H.264 subclause 8.2.5.3 describes the sliding-window mechanism that manages the DPB. This subclause includes a statement that is equivalent to the following pseudocode:
If ((numShortTerm+numLongTerm)==Max(num_ref frames, 1)) Then Mark oldest short-term reference frame as “unused for reference”,
where numShortTerm and numLongTerm indicate the number of short-term and long-term reference frames in the DPB, respectively, so that (numShortTerm+numLongTerm) indicates the actual size of the window of reference frames. Therefore, the preceding pseudocode removes the oldest short-term reference frame from the window when the window attains the maximum size specified by num_ref frames. However, consider a scenario in which (numShortTerm +numLongTerm)=8 and num_ref frames=8 but due to a burst error, num_-ref frames has been corrupted to 2. In this case, the test in the preceding pseudocode would fail and the oldest short-term reference frame would not be removed from the window. Consequently, the DPB would contain an unnecessary reference frame that may cause the decoder to consume all remaining DPB buffers faster than anticipated by the encoder that created the bitstream. The decoder would then crash due to the absence of a DPB buffer to hold a decoded frame.

To detect and recover from this error scenario, preferred embodiment methods modify the preceding pseudocode to read as follows (see FIG. 1c):

ERR_NUM_REF_FRAMES = 0;
If ((numShortTerm + numLongTerm) > Max(num_ref_frames, 1)) Then

ERR_NUM_REF_FRAMES = 1;

If (((numShortTerm + numLong Term) == Max(num_ref_frames 1)) ||

(ERR_NUM_REF_FRAMES == 1)) Then

Mark oldest short-term reference frame as “unused for reference”

Clearly, even in the previously described error scenario, preferred embodiment modified pseudo-code will remove the oldest short-term reference frame from the window, thus preventing a decoder crash. Furthermore, this error-recovery mechanism does not affect the normal operation of the sliding-window mechanism in an error-free environment. However, if the num_ref frames syntax element does get corrupted, then the ERR_NUM_REF_FRAMES flag will be set to notify the decoder that the bitstream has been corrupted.

B) Recovering From Coffupted SPS Or PPS

If errors are detected in the sequence parameter set or picture parameter set, the errors are generally unrecoverable, because SPS and PPS contain essential parsing (number of bits) and display (height, width, ordering) information. In bitstreams with random access, such as for mobile TV, the SPS and PPS are repeated at frequent intervals. In this case, the values typically do not change in the bitstream. In some cases, the SPS and PPS values may be fixed for a particular application. In the preferred embodiment method, if the first SPS or PPS is corrupted, and the values are not known a priori, then search for the next SPS or PPS and skip any data in between. In other words, the start is delayed, until an uncorrupted SPS/PPS is found. Once an error-free SPS or PPS is decoded, if an error is detected in a subsequent SPS/PPS, the decoder should simply stop parsing, re-use the error-free SPS/PPS, and go to the next NAL unit. See FIG. 1d. Some errors may not be detectable without a priori knowledge, but frequent repetition of the SPS and PPS enhances error recovery as well as providing random access.

4. Error Concealment

Some errors are not detectable, and in bursty error conditions, it is generally best to discard and conceal an entire slice, once an error is detected, rather than risk displaying corrupted data. Because H.264 allows arbitrary macroblock ordering and transmission of redundant data, concealment is not performed until the start of the next frame is detected, based on pic_order_cnt With H.264, sometimes SEI data may be used for concealment. SEI may contain Spare picture (where to copy from) or Scene information (to indicate a scene change).

Generally, temporal concealment is performed by copying missing pixel data from the previous reference frame, or the most probable reference frame. If there is no valid reference frame, such as for the first frame or when SEI indicates a scene change, then a grey or smooth block can be substituted for the missing data. A grey block provides a maximum likelihood estimate, given no a priori knowledge, because it is at the middle of the range of YUV values, and it is usually preferable to displaying uninitialized or corrupted data, which may be brightly colored. If only some macroblocks from a frame are missing, spatial concealment can be used to fill in the block in a smooth way. Starting with a smooth background, the viewer is able to see moving edges in subsequent frames.

In the H.264 standard the gaps_in_frame_num_value_allowed flag enables easy detection of certain errors. However, the standard does not provide a technique to conceal these detected errors which may result in disordered frames. It is important to conceal these errors because other concealment techniques will perform badly on disordered frames. The following sub-section discusses a preferred embodiment method to conceal these errors.

Concealing Errors Due To Invalid Gaps In The Frame_Num Sequence:

To achieve temporal scalability, a bitstream at a lower frame-rate may be created by skipping certain non-reference frames in another bitstream. However, the sequence of frame_num syntax elements in the low frame-rate bitstream will now have gaps at the locations of the skipped frames. Furthermore, these skipped frames will not be stored in the DPB and therefore the DPB-management specifications contained in the original bitstream cannot be used in the low frame-rate bitstream. To overcome these problems and enable temporal scalability through frame skipping, the decoder creates non-existing “fake” frames to serve as DPB placeholders for skipped frames which are detected through gaps in the frame_num sequence of syntax elements obtained from bitstream slice headers. This process is detailed in H.264 subclauses 8.2.5.2 and C.4.2 and summarized in the following pseudocode:

If ((SliceHeader.frame_num != prevFrameNum) &&

(SliceHeader.frame_num != ((prevFrameNum + 1) % MaxFrame
Num))) Then

If (gaps_in_frame_num_value_allowed_flag) Then

//Process valid gap in frame_num sequence.

handleFrameNumGaps( ); // Apply subclauses 8.2.5.2,
C.4.2.

Else

// Invalid gap in frame_num sequence.
// Error concealment should be applied here,

where SliceHeader.frame_num and prevFrameNum refer to the frame_num syntax element decoded from the current and previous frames, respectively; and the gaps_in_frame_num_value_allowed flag syntax element is decoded from the slice header in the current frame. The MaxFrameNum syntax element is used to wrap values into the finite range [0,MaxFrameNum).

As shown in the preceding pseudocode, if the current frame_num syntax element differs from the previous frame_num syntax element by more than one, then a gap in the frame_num sequence has been detected. If the gaps in_frame_num_value_allowed flag syntax element is set, then the gap is valid and should be processed as specified in subclauses 8.2.5.2 and C.4.2. Otherwise, the gap in the frame_num sequence is due to an error condition and concealment should be applied.

To conceal errors due to an invalid gap in the frame_num sequence, preferred embodiment methods may apply the strategy summarized in the following pseudocode (see FIG. 1e):

If ((SliceHeader.frame_num != prevFrameNum) &&

(SliceHeader.frame_num != ((prevFrameNum + 1) % MaxFrame
Num))) Then

If(gaps_in_frame_num_value_allowed_flag) Then

//Process valid gap in frame_num sequence.

handleFrameNumGaps( ); //Apply SubClauses 8.2.5.2 and
C.4.2.

Else { //Apply error concealment.

If(SliceHeader.frame_num == (prevFrameNum+2) % Max
FrameNum) Then

// frame_num is probably correct and a frame has been
missed.

return ERR_FRAMEGAP;

Else { // frame_num is probably incorrect. Correct it.

If(nal_ref_idc != 0) Then

SliceHeader.frame_num = (prevFrameNum + 1) %
MaxFrameNum

Else

SliceHeader.frame_num = prevFrameNum %
MaxFrameNum

}

}

where the nal_ref idc syntax element indicates whether the current frame is a reference frame.

As shown in the preceding pseudocode, for error concealment following an invalid gap in the frame_num sequence, first determine whether the current frame_num syntax element differs from the previous frame_num syntax element by 2 or by more than 2. When the difference is equal to 2, it is probable that the frame_num syntax element itself is correct but due to bitstream errors we have failed to decode the frame which has the “missing” frame_num given by (prevFrameNum+1) % MaxFrameNum. In this case, return the error indicator ERR_FRAMEGAP to inform the calling function of the inferred error scenario, so that temporal concealment from the preceding frame may be applied. In the second case, when the difference between the current frame_num syntax element and the previous frame_num syntax element is more than 2, then there are at least two possible scenarios. In the first (unlikely) scenario, the frame_num syntax element is correct and the invalid gap occurs because there has been a failure to decode at least two intervening frames. This first scenario is less probable than the second scenario in which all intervening frames have been decoded but the frame_num syntax element itself is corrupt. Assuming that the more probable second scenario always holds true, the preferred embodiment methods attempt to restore the frame_num syntax element to the correct value which is one more than the previous frame_num value for a reference frame, but otherwise is equal to the previous frame_num value.

5. Experimental Results

Because a preferred embodiment method detects, recovers from and conceals bit errors, burst errors and packet-loss errors, a decoder that uses a preferred embodiment method is extremely robust to a variety of error conditions. For testing, Baseline-Profile H.264-encoded versions of the 300-frame foreman sequence as well as 713 frames of the Korean Digital Mobile Broadcast Sports (KDMBS) sequence were used. For each bitstream, 10 realizations were created for each of the 8 test conditions shown in the following Table. It was verified that a preferred embodiment solution provides error robustness in all 80 cases. In addition, byte-by-byte corruption of the first 6728 bytes of the KDMBS sequence were performed and confirmed the error resilience of a preferred embodiment solution in all 6728 cases. In another test, bit-by-bit corruption of the first sequence parameter set of the KDMBS sequence were performed and observed that a preferred embodiment solution protects the decoder from errors in 4308 tested cases.

| | BER | Burst len | Burst BER | Packet len | PLR |
|---|---|---|---|---|---|
| 1 | 1.0 E−3 | | | | |
| random | | | | | |
| 2 burst | 1.0 E−2 | 1 | 0.5 | | |
| 3 burst | 1.0 E−2 | 10 | 0.5 | | |
| 4 burst | 1.0 E−2 | 20 | 0.5 | | |
| 5 burst | 1.0 E−3 | 1 | 0.5 | | |
| 6 burst | 1.0 E−3 | 10 | 0.5 | | |
| 7 packet | | | | 96/200/400 bits | 1.0 E−2 |
| loss | | | | (equal probability) | |
| 8 packet | | | | 96/200/400 bits | 3.0 E−2 |
| loss | | | | | |

6. Error Examples

The following tables list various errors with respect to H.264 semantics.

TABLE 1
Errors detected at or below the macroblock level

| subroutine | condition | comment |
|---|---|---|
| UVLD_CBP | UnsignedExpGol | Access |
| | code_number > 47 | violation |
| UVLD_MBTYPE | UnsignedExpGol code number = | |
| | ERR_DATA | |
| UVLD_MBTYPE | Codenumber > 25 for I frames | |
| UVLD_MBTYPE | Codenumber > 30 for P frames | |
| MVDecoding | SignedExpGol returns | |
| | ERR_DATA | |
| MVDecoding | Check MVDy range level limit | Because there |
| | (Table A-1) | are variable |
| | | number of |
| | | MVs per MB, |
| | | it is best to |
| | | check it here. |
| | | ref_mvx/y are |
| | | also affected. |
| MVDecoding | Check MVDx range between | |
| | −2048 and 2047.75 | |
| DecodeMacroblock | Intra_pred_model[k] > 8 for | |
| | INTRA4×4 | |
| DecodeMacroblock | Intra_chroma_pred_mode > 3 | |
| | for INTRA4×4 or 16×16 | |
| DecodeMacroblock | Sub_mb_type > 3 | |
| DecodeMacroblock | RefFwd[ ] > | |
| | num_ref_idx_10_active_minus1 | |
| DecodeMacroblock | Mb_qp_delta > 25 or < 31 26 | |
| DeocdeMacroblock | Slice_type = I and mb_type | |
| | not INTRA | |
| IMXLumaBlockMC | *Pred > 255, *pred < 0 | Automatic |
| (also chroma?) | | saturation? |

TABLE 2
Errors detected above the macroblock level

| Subroutine | condition | comment |
|---|---|---|
| H26LdecodeFrame | Check if UexpGol RUN would exceed | Segmentation fault |
| | number of MBs per frame | |
| Decode_seq_parameter_set_rbsp | Check for valid level_idc | Table A-1 |
| Decode_seq_parameter_set_rbsp | Seq_parameter_set_id > 31 | |
| Decode_seq_parameter_set_rbsp | Log2_max_frame_num_minus4 > 12 | |
| Decode_seq_parameter_set_rbsp | Pic_order_cnt_type > 2 | |
| Decode_seq_parameter_set_rbsp | Log2_max_pic_order_cnt_lsb_minus4 > 12 | |
| Decode_seq_parameter_set_rbsp | Offset_for_non_ref_pic out of range | New routine |
| | | LongSignedExpGol |
| | | ombDecoding |
| Decode_seq_parameter_set_rbsp | Offset_for_top_to_bottom_field out of | New routine |
| | range | LongSignedExp- |
| | | GolombDecoding |
| Decode_seq_parameter_set_rbsp | Num_ref_frames_in_pic_order_cnt_cycle > 255 | |
| Decode_seq_parameter_set_rbsp | Offset_for_ref_frame[I] out of range | New routine |
| | | LongSignedExp- |
| | | GolombDecoding |
| Decode_seq_parameter_set_rbsp | Num_ref_frames > 16 | |
| Decode_seq_parameter_set_rbsp | Mb_width > sqrt(MaxFS*8) | A.3.1 f) |
| Decode_seq_parameter_set_rbsp | Mb_height > sqrt(MaxFS*8) | A.3.1 g) |
| Decode_seq_parameter_set_rbsp | Pic_size > MaxFS[level_idc] | Table A-1 |
| Decode_seq_parameter_set_rbsp | Frame_crop_left_offset > 8*mb_width − | |
| | (frame_crop_right_offset + 1) for | |
| | frame_mbs_only_flag = 1 | |
| Decode_seq_parameter_set_rbsp | Frame_crop_top_offset > 8*mb_height − | |
| | (frame_crop_bottom_offset + 1) for | |
| | frame_mbs_only_flag = 1 | |
| Decode_seq_parameter_set_rbsp | Frame_crop_top_offset > 4*mb_height − | Frame_mbs_only_- |
| | (frame_crop_bottom_offset + 1) for | flag must be 1 for |
| | frame_mbs_only_flag = 0 | baseline profile |
| | | (A.2.1), but check is |
| | | included in case |
| | | other profiles are |
| | | added later |
| Decode_pic_parameter_set_rbsp | Pic_parameter_set_id > 255 | |
| Decode_pic_parameter_set_rbsp | Seq_parameter_set_id > 31 | |
| Decode_pic_parameter_set_rbsp | Slice_group_map_type > 6 | |
| Decode_pic_parameter_set_rbsp | Run_length _minus1[I] > | |
| | PicSizeInMapUnits | |
| Decode_pic_parameter_set_rbsp | Top_left[i] > bottom_right[i] | |
| Decode_pic_parameter_set_rbsp | Bottom_right >= PicSizeInMapUnits | |
| Decode_pic_parameter_set_rbsp | Top_left[I] % PicWidthInMbs > | |
| | bottom_right[I] % PicWidthInMbs | |
| Decode_pic_parameter_set_rbsp | Slice_group_change_rate_minus1 >= | |
| | PicSizeInMapUnits | |
| Decode_pic_parameter_set_rbsp | Pic_size_in_map_units_minus1 != | |
| | PicSizeInMapUnits − 1 | |
| Decode_pic_parameter_set_rbsp | Slice_group_id[I] > num_slice_groups_minus1 | |
| Decode_pic_parameter_set_rbsp | Num_ref_idx_10_active_minus1 > 31 | |
| Decode_pic_parameter_set_rbsp | Num_ref_idx_11_active_minus1 > 31 | |
| Decode_pic_parameter_set_rbsp | Pic_init_qp_minus26 > 25 | |
| Decode_pic_parameter_set_rbsp | Pic_init_qp_minus26 > −26 | |
| Decode_pic_parameter_set_rbsp | Pic_init_qs_minus26 > 25 | |
| Decode_pic_parameter_set_rbsp | Pic_init_qs_minus26 < −26 | |
| Decode_pic_parameter_set_rbsp | Chroma_qp_index_offset > 12 | |
| Decode_pic_parameter_set_rbsp | Chroma_qp_index_offset < −12 | |
| Decode slice header | When present, the values of | (see 7.4.3 first |
| | pic_parameter_set_id, frame_num, | sentence) |
| | field_pic_flag, bottom_field_flag, | Would need to store |
| | idr_pic_id, pic_order_cnt_lsb, | these fields for every |
| | delta_pic_order_cnt_bottom, | slice header for |
| | delta_pic_order_cnt[0/1], | comparison |
| | sp_for_switch_flag and | |
| | slice_group_change_cycle shall be the | |
| | same in all slice headers of a coded picture. | |
| Decode_slice_header | First_mb_in_slice > PicSizeInMbs − 1 | |
| Decode_slice_header | Nal_unit_type == 5 and slice_type != I | |
| Decode_slice_header | Pic_parameter_set_id > 255 | |
| Decode_slice_header | Frame_num in constrained (7.4.3) | |
| Decode_slice_header | Frame_num != 0 for nal_unit_type==5 | |
| Decode_slice_header | Idr_pic_id > 65535 | New routine |
| | | LongUnsignedExp- |
| | | GolombDecoding |
| Decode slice header | Delta_pic_order_cnt_bottom > (1 − | |
| | MaxPicOrderCntLsb) for | |
| | memory_management_control_operation = 5 | |
| Decode slice header | Delta_pic_order_cnt[0]/[1]/bottom out of range | New routine |
| | | LongSignedExp- |
| | | GolombDecoding |
| Decode_ref_list_pic_reordering | Reordering_of_pic_nums_ids > 3 | Infinite loop |
| Decode_ref_list_pic_reordering | Abs_diff_pic_num_minus1 == ERR_DATA | Other restrictions in |
| | | 7.4.3.1 and 8.2.4.3.1 |
| Decode_ref_list_pic_reordering | Long_term_pic_num > | Assumes no |
| | max_long_term_frame_idx_plus1 − 1 | interlace (8.2.4.1) |
| | | Other restrictions |
| | | in 7.4.3.1 |

TABLE 3
Error detection that is specific to Baseline Profile (A.2.1)

| Subroutine | condition | comment |
|---|---|---|
| Decode_seq_parameter_set_rbsp | Profile_idc != 66 && | |
| | constraint_set0_flag!= 1 | |
| Decode_seq_parameter_set_rbsp | Frame_mbs_only_flag != 1 | Does this restrict |
| | | pic_order_cnt_type or |
| | | offset_for_top_to_- |
| | | bottom_field? Others? |
| Decode_pic_parameter_set_rbsp | Nal_unit_type = 2,3,4 | |
| Decode_pic_parameter_set_rbsp | Entropy_coding_mode_flag != 0 | |
| Decode_pic_parameter_set_rbsp | Num_slice_groups_minus1 > 7 | |
| Decode_pic_parameter_set_rbsp | Num_slice_groups_minus1 != 1 and | |
| | slice_group_map_type = 3,4 or 5 | |
| Decode_pic_parameter_set_rbsp | Weighted_pred_flag != 0 | |
| Decode_pic_parameter_set_rbsp | Weighted_bipred_idc != 0 | |
| Decode_slice_header | Slice_type != I && slice_type != P | |

TABLE 4
Error checking that is specific to one implementation

| Subroutine | condition | comment |
|---|---|---|
| Main | Fp == NULL (input file not found) | Segmentation fault |
| Main | Nal_unit_type = 0, 2-4, 6, > 11 | Discard these nal_units (not handled) |
| Main | Decode_seq_parameter_set_r | |
| | bsp returns errflg | |
| Main | Decode_pic_parameter_set_r | |
| | bsp returns errflg | |
| Main | H26LDecodeFrame returns errflg | |
| Main | Loop terminates for | Infinite loop |
| | nal_unit_type = 9 or 10, but | |
| | do not require previous 3 bits = 0 | |
| Residual_CAVLD | Residual_block_cavld returns errflg | |
| Residual_block_cavld | UNLDecode returns errflg | |
| UVLDecode | Dcdtab[code] = 0 returns error | |
| H26LdecodeFrame | Add errflg==0 check to some | |
| | while/if conditions | |
| H26LdecodeFrame | Decode_slice_header returns errflg | |
| DecodeMacroblock | UVLD_CBP returns errflg | |
| Decode_seq_parameter_set_rbsp | Check level_idc | (Set MIN_LEVEL and |
| | | MAX_LEVEL.) |
| Decode_seq_parameter_set_rbsp | Pic_width_in_mbs_minus1 = | Also, should avoid exceeding |
| | ERR_DATA from | memory. There may be a Level |
| | UnsignedExpGolomb-Decoding | constraint |
| Decode_seq_parameter_set_rbsp | Pic_height_in_map_units_- | Also, should avoid exceeding |
| | minus1 = ERR_DATA from | memory |
| | UnsignedExpGolomb-Decoding | |
| Decode_slice_header | Returns errflg | |
| Decode_ref_pic_list_reordering | Returns errflg | |

What is claimed is:

1. A method of decoding codewords with a variable number of leading 0s, comprising:
(a) providing a maximum for the number of leading 0s in a codeword;
(b) checking whether the number of leading Os of a received codeword exceeds said maximum;
(c) when said checking of step (b) indicates said received codeword has more leading 0s than said maximum, reporting an error.

2. The method of claim 1, wherein:
(a) said maximum is selected from the group consisting of 15 and 31.

3. A method of managing a decoded picture buffer, comprising:
(a) providing a maximum for the number of short-term items plus the number of long-term items in a decoded picture buffer;
(b) when the number of short-term items plus the number of long-term items in said decoded picture buffer exceeds said maximum, indicating an error;
(c) when either (i) said step (b) indicates an error or (ii) said number of short-term items plus number of long-term items equals said maximum, marking one of said short-term items as unused.

4. A method of parsing an encoded video stream, comprising:
(a) receiving a sequence of network abstraction layer units;
(b) when an error is detected in a sequence parameter set (SPS) unit or a picture parameter set (PPS) unit in said sequence, discard said SPS unit or PPS unit, respectively, and reuse a prior SPS unit or PPS unit which is error-free, respectively.

5. The method of claim 4, wherein:
(a) when in step (b) of claim 4 there is no prior SPS unit or PPS unit which is error-free, respectively, discard units in said sequence until an error-free SPS unit or PPS unit, respectively, is found.

6. A method of video decoding, comprising:
(a) receiving a sequence of slices of frames;
(b) when a frame number of a slice differs from a frame number for the previous slice by more than 2, then change said frame number of said slice.

7. The method of claim 6, wherein:
(a) when said slice is not part of a reference frame, said step (b) of claim 6 changes said frame number of said slice to said frame number for the previous slice.
